(19) United States
(12) Patent Application Publication
(10) Pub. No.: US 2021/0148654 A1
(43) Pub. Date: May 20, 2021

(54) HEAT EXCHANGER COMPRISING CONNECTING DUCTS FOR THE SUPPLY AND DISCHARGE OF A HEAT TRANSFER FLUID

(71) Applicant: Valeo Systemes Thermiques, Le Mesnil-Saint-Denis Cedex (FR)

(72) Inventors: Fethy Djallal, La Suze Sur Sarthe (FR); Julien Veron, La Suze Sur Sarthe (FR); Thibaut Perrin, La Suze Sur Sarthe (FR)

(73) Assignee: Valeo Systemes Thermiques, Le Mesnil-Saint-Denis Cedex (FR)

(21) Appl. No.: 17/048,750

(22) PCT Filed: Apr. 17, 2019
(86) PCT No.: PCT/FR2019/050916

§ 371 Date: Nov. 11, 2020

(30) Foreign Application Priority Data
Apr. 19, 2018 (FR) 1853433

(51) Int. Cl. F28F 9/02; F28F 3/12

(52) U.S. Cl. CPC F28F 9/0246; F28F 3/12

(57) ABSTRACT

The present invention relates to a heat exchanger (1) comprising an inlet duct (31) and an outlet duct (32) for a heat transfer fluid, onto which ducts a supply pipe (21) and a discharge pipe (22) for the heat transfer fluid are respectively intended to be inserted.

According to the invention, the inlet duct (31) and the outlet duct (32) each have, on their outer surface, means for sealing and retaining the corresponding pipe (21, 22), and a collar (34) forming a stop for limiting the insertion of the pipe (21, 22) onto the corresponding duct (31, 32).

### 1. FIELD OF THE INVENTION

The invention relates to the field of the thermal regulation of batteries, and more particularly relates to heat exchangers for the thermal management of batteries, in particular in the automotive field.

The invention relates more specifically to the connection between such a heat exchanger and a thermal regulation circuit in which a heat transfer fluid circulates.

### 2. PRIOR ART

The electrical energy for electrically-powered and/or hybrid-powered motor vehicles is supplied by one or more batteries.

In this type of vehicle, the battery is generally formed from a plurality of electrical energy storage cells that form one or more modules disposed in a protective casing so as to form what is known as a battery pack.

The thermal regulation of the battery is an important matter.

Specifically, the temperature of the battery needs to be regulated to a temperature close to 20° in order to ensure the reliability, range and performance level of the vehicle, while optimizing the service life of the battery.

In order to regulate the temperature of the battery, it is known to use a thermal regulation device that provides the functions of heating and cooling the battery.

Such a thermal regulation device comprises in particular a heat exchanger that delimits a circuit for the circulation of a heat transfer fluid and is disposed in thermal contact with the electric cells of the battery.

The heat transfer fluid is introduced into the circulation circuit, and evacuated therefrom, by way of supply and discharge pipes, which are connected in a sealed manner to inlet and outlet ducts borne by the heat exchanger.

To this end, the supply and discharge pipes are forcibly inserted onto the inlet and outlet ducts of the heat exchanger.

At the end of insertion, the ends of the pipes may come into contact with the surface of the exchanger, which then has to absorb relatively large forces that may possibly go so far as to cause it to deteriorate (in particular to deform).

The force-fitting of the pipes onto the ducts of the heat exchanger also generates dimensional deviations (spread) in the mounting of the pipes on the exchanger.

Once the pipes are positioned on the inlet and outlet ducts of the heat exchanger, a clamping ring is conventionally positioned around the pipes so as to ensure that the connection between the pipes and the ducts of the heat exchanger is sealed.

There is therefore a need to propose a solution for connection between the inlet and outlet ducts of a heat exchanger and the heat transfer fluid supply and discharge pipes, which is reliable and sealed, of simple design, quick to implement, and which minimizes the risk of deterioration of the heat exchanger.

### 3. SUMMARY OF THE INVENTION

To this end, the invention proposes a heat exchanger comprising an inlet duct and an outlet duct for a heat transfer fluid, onto which ducts a supply pipe and a discharge pipe for the heat transfer fluid are respectively intended to be inserted.

According to the invention, said inlet duct and said outlet duct each have, on their outer surface, means for sealing and retaining said pipe, and a collar forming a stop for limiting the insertion of said pipe onto said corresponding duct.

The invention consists in providing on the inlet and outlet ducts of a heat exchanger—means for sealing and retaining the pipes of a thermal regulation circuit that are inserted onto these ducts, and—collars forming stops that are intended to limit the axial insertion of the pipes onto the ducts so as not to damage the heat exchanger when the heat exchanger is connected to the thermal regulation circuit.

The collar serves as an axial stop at one end of the pipe when the latter is fitted onto the corresponding duct.

It exerts a counter-force at the end of the insertion or placement of the pipe onto the duct, so that the force generated by the end of the pipe at the end of the insertion is no longer applied to the surface of the exchanger (thus avoiding deformation thereof) but to the collar of the duct (the collar is subjected to and therefore cushions the forces involved in forcibly assembling the pipe onto the duct).

The means for sealing and retaining the pipe have two functions.

On the one hand, they make it possible to establish a seal between the duct and the corresponding pipe, and thus to prevent any leakage of the heat transfer liquid circulating in the ducts.

On the other hand, they make it possible to lock the pipe in position on the corresponding duct, once the end of the latter has come into contact with the collar, so that the risk of accidental removal of the pipe is minimized.

The solution of the invention is of simple design, makes mounting easier, and minimizes the risk of deterioration of the heat exchanger.

According to a particular aspect of the invention, a groove is formed beneath the stop. This groove is appropriate for receiving a tool or a part of an assembly means in order to position the collar in said assembly means, thus making it possible to precisely control the fitting of the pipe onto the corresponding duct.

According to a particular aspect of the invention, one end of said inlet duct and one end of said outlet duct are secured respectively to an inlet port and an outlet port for the heat transfer fluid that are borne by said heat exchanger.

The ducts are mounted on the corresponding ports of the heat exchanger, for example by welding or brazing, so as to form an inseparable assembly with the heat exchanger.

It is therefore not necessary to use specific sealing elements between the ports of the heat exchanger and the ducts for connecting the exchanger to a thermal regulation circuit.

According to a particular aspect of the invention, said collar is situated in the vicinity of the end of said duct that is secured to said port.

The collar forming a stop for the end of the pipe, which extends over the periphery of the duct, is situated in the vicinity of the surface of the exchanger.

In this way, the “free” duct length, i.e. that which is intended to receive the pipe before it is brought into abutment, is large enough to allow the pipe to be correctly placed onto the duct.

According to a particular aspect of the invention, said collar extends at least partially over the outer surface of said duct.

The collar extends over the entire external periphery of the duct or else over only a portion, its function being to limit the axial insertion of the pipe onto the duct.

According to a particular aspect of the invention, said sealing and retaining means comprise at least one circular tooth that is borne by the outer surface of said duct.

The presence of at least one tooth, or projection, on the external surface of the duct makes it possible to establish a seal between the external surface of the duct and the inner surface of the corresponding pipe, by filling the gap that exists between the pipe and the duct.

According to a particular aspect of the invention, said at least one tooth has a cross section in the form of a truncated cone of which the base faces said collar.

This specific tooth profile has the advantage of eliminating or at the very least minimizing the risk of accidental removal of the pipe, when it is inserted onto the corresponding duct.

According to a particular aspect of the invention, said sealing and retaining means comprise three circular teeth that are spaced along the outer surface of the duct.

The presence of three spaced-apart teeth, or projections, further optimizes the seal between the duct and the corresponding pipe, and further reduces the risk of accidental removal of the pipe.

According to a particular aspect of the invention, said inlet duct and said outlet duct each have means for the angular positioning of said corresponding pipe on said duct that are intended to cooperate with complementary angular positioning means formed in each of said pipes.

The angular positioning means formed on the ducts and the pipes make it possible, on the one hand, to precisely place the end of the pipe in a predetermined position around the corresponding duct, and on the other hand to rotationally lock the pipe on the corresponding duct.

According to a particular aspect of the invention, said angular positioning means comprise at least one notch formed in said collar, appropriate for cooperating with at least one lug borne by said pipe.

These angular positioning means are relatively easy to implement, and make the assembly operations easier.

According to a particular aspect of the invention, said angular positioning means comprise at least one lug borne by said collar, appropriate for cooperating with at least one notch formed in said pipe.

This constitutes an alternative for the angular positioning of the pipe relative to the corresponding duct.

The invention also relates to a thermal regulation assembly comprising a heat exchanger as described above, and at least one pipe for supplying heat transfer fluid to said heat exchanger and one pipe for discharging the heat transfer fluid out of said heat exchanger.

### 4. FIGURES

Other features and advantages will become more clearly apparent upon reading the following detailed description of particular embodiments of the invention, which are given by way of simple, non-limiting illustrative examples, and the appended drawings, in which:

FIG. 1 is a perspective view of a plate-type heat exchanger, comprising an inlet duct and an outlet duct for a heat transfer fluid, to which ducts a supply pipe and a discharge pipe for the fluid are respectively connected;

FIG. 2 is a close-up view of the two ducts, each comprising sealing and retaining means, and a collar forming a stop, before fitting of the pipes;

FIG. 3 is a close-up view of the two ducts, after fitting of the pipes, the ends of the pipes abutting the collars of the ducts;

FIGS. 4 and 5 illustrate a first embodiment of the angular positioning means, before and after fitting of the pipes onto the ducts, in which the collar of each duct is provided with a notch that is intended to cooperate with a lug formed on the corresponding pipe;

FIGS. 6 and 7 illustrate a second embodiment of the angular positioning means, before and after fitting of the pipes onto the ducts, in which the collar of each duct is provided with a lug that is intended to cooperate with a notch formed in the corresponding pipe.

### 5. DETAILED DESCRIPTION

### 5.1 General Principle of the Invention

The invention proposes optimizing the operations for connection between a heat exchanger, of plate type or tube type, that delimits a circuit for a heat transfer fluid, and the supply and discharge pipes for the heat transfer fluid.

To this end, the invention proposes that the heat exchanger comprise an inlet duct and an outlet duct for the heat transfer fluid that have a specific profile, these ducts being secured respectively to an inlet port and to an outlet port for the heat transfer fluid of the exchanger.

These ducts are each intended to cooperate with a flexible or semi-rigid pipe for providing or discharging the heat transfer fluid in the exchanger.

Thus, a supply pipe for the heat transfer fluid is fitted onto the inlet duct of the heat exchanger and the discharge pipe for the heat transfer fluid is fitted onto the outlet duct of the heat exchanger.

According to the general principle of the invention, each of the inlet and outlet ducts of the heat exchanger has means that make it possible both to establish a seal between the duct of the heat exchanger and the corresponding pipe, and to keep the pipe in position on the duct of the heat exchanger.

Thus, the sealing means are provided directly on the ducts of the heat exchanger, and this avoids the implementation of gaskets and other additional sealing elements, and simplifies the assembly operations and the reliability of the assembly.

Nor is it necessary to add additional elements for locking the position of the pipe on the duct of the heat exchanger, of the ring type for example, since the shape of the ducts is configured to retain the pipe on the duct.

Furthermore, the inlet duct and the outlet duct of the heat exchanger also comprise a collar forming an axial stop for the end of the pipe that fits onto the duct.

Thus, the forces involved in force-fitting the pipe onto the duct are absorbed by the collar and not by the surface of the heat exchanger, which prevents damage to the latter.

### 5.2 Description of Several Embodiments of the Invention

In the various figures, unless otherwise indicated, identical elements bear the same reference numbers and have the same technical characteristics and modes of operation.

In the following text, the present invention is described in connection with a plate-type heat exchanger, but also applies to a tube-type heat exchanger.

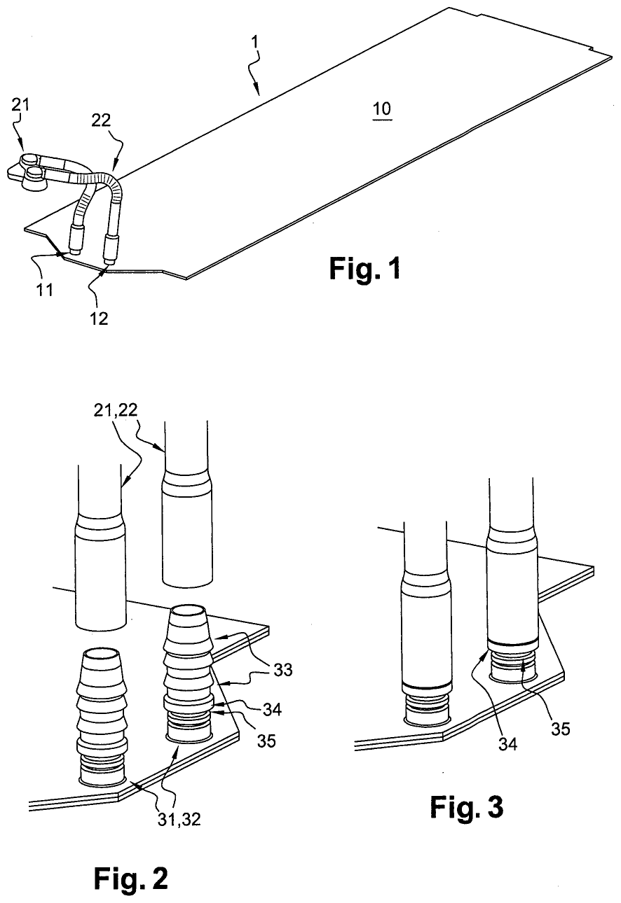

A plate-type heat exchanger 1 is illustrated in FIG. 1.

It comprises two adjoining plates, one of which is intended to be placed in thermal contact with the batteries of a motor vehicle of electric or hybrid type for thermal regulation thereof, the two plates delimiting between them a circuit for the circulation of a heat transfer fluid.

The surface 10 of the upper plate bears an inlet port 11 and an outlet port 12 for the heat transfer fluid, taking the form of a neck of the plate, which are intended to be connected respectively to a supply pipe 21 and to an evacuation pipe 22 for the fluid that are connected to a thermal regulation loop of a vehicle, in this example.

The supply 21 and discharge 22 pipes for the fluid are preferably flexible or semi-rigid, and for example made from a material chosen from a polyamide 6, a polyamide 12, a copolymer or a composite material.

In order to connect the pipes 21, 22 to the inlet port 11 and to the outlet port 12 respectively of the heat exchanger 1, the invention provides for the use of connecting ducts or sleeves 31, 32, and more specifically an inlet duct 31 and an outlet duct 32, which are shown in FIG. 2.

One of the ends of each of the connection ducts 31, 32 is secured in a sealed manner to the respective port 11, 12, preferably by brazing or welding.

The connection ducts 31, 32 are, for example, made of aluminum.

As can be seen in FIG. 2, the connection ducts 31, 32 have a specific profile that provides both a sealing function and a function of holding the pipes 21, 22 in position, once the latter have been force-fitted onto the connection ducts 31, 32.

More specifically, each connection duct 31, 32 comprises, on its substantially cylindrical outer surface, a plurality of arranged circular teeth 33, or projections.

In the example illustrated, three peripheral circular teeth 33 are regularly spaced along the main axis of each connection duct 31, 32, on the periphery of the latter.

The main axis is defined in this case as being the longitudinal axis of the connection ducts 31, 32, perpendicular to the surface 10 of the heat exchanger 1.

Each tooth 33, viewed along a plane that includes the main axis of the connection duct, has a profile in the form of a truncated cone.

The base of the truncated cone, which is wider than its apex, is oriented toward the inlet 11 and outlet 12 ports of the heat exchanger 1.

This tooth profile, which can schematically be defined as a “fir-tree” shape, makes it possible to ensure that the assembly between the pipes 21, 22 and the connection ducts 31, 32 is sealed.

The connection ducts 31, 32 could have a greater or lesser number of teeth 33, the distribution of these teeth 33 along the main axis being able to differ from that illustrated in the figures.

Furthermore, the profile of the teeth 33 makes it possible to retain the pipes 21, 22 on the connection ducts 31, 32 once the pipes 21, 22 have been inserted onto the ducts: this is because the teeth 33 widen toward the surface 10 of the heat exchanger 1, and this eliminates, or at the very least minimizes, the risk of accidental removal of the pipes 21, 22.

According to the invention, each connection duct 31, 32 bears a collar 34, forming a stop, which extends over the outer surface of the connection duct 31, 32, in the vicinity of the corresponding inlet 11 or outlet 12 port, i.e. in the vicinity of the end of the connection duct 31, 32 that is oriented toward the heat exchanger 1.

The collar 34 is more specifically located between the plurality of teeth 33 and the corresponding port 11, 12, along the main axis of the connection duct 31, 32.

This collar 34 may be “integral”, i.e. formed over the entire periphery of the connection duct 31, 32, or “partial”, i.e. formed only over a portion of the periphery of the connection duct 31, 32.

When a pipe 21, 22 is forcibly inserted onto the corresponding connection duct 31, 32, its free end bears against the collar 34, as illustrated in FIG. 3.

The main function of the collar 34 is therefore to limit the axial insertion of the pipe 21, 22 and to absorb the forces at the end of the operation of fitting the pipe 21, 22 onto the corresponding connection duct 31, 32, and this prevents the surface 10 of the heat exchanger 1 from being subjected to these forces and from being damaged.

In other words, the collar 34 makes it possible to counter the forces that are applied by the end of the pipe 21, 22 at the end of the movement of pressing the pipe 21, 22 onto the corresponding connection duct 31, 32.

The collar 34 also makes it possible to position the end of the pipe 21, 22 on the connection duct 31, 32 with minimal spread, since the positioning is done from the collar 34 directly and not from the surface 10 of the heat exchanger 1, thus limiting the chain of dimensions.

According to an optional aspect of the invention, a groove 35 is formed beneath the collar 34. This groove 35 is appropriate for receiving a tool or a part of an assembly means (not shown here) in order to position the collar 34 in said assembly means, thus making it possible to precisely control the fitting of the pipe 21, 22 onto the corresponding connection duct 31, 32.

According to an optional aspect of the invention, the connection ducts 31, 32 can additionally bear means for the angular positioning of the pipe 21, 22 relative to the heat exchanger 1.

These angular positioning means, formed on the collar 34 of the connecting ducts 31, 32, can take the form of a notch or a lug and are intended to cooperate with complementary angular positioning means formed at the free ends of the pipes 21, 22.

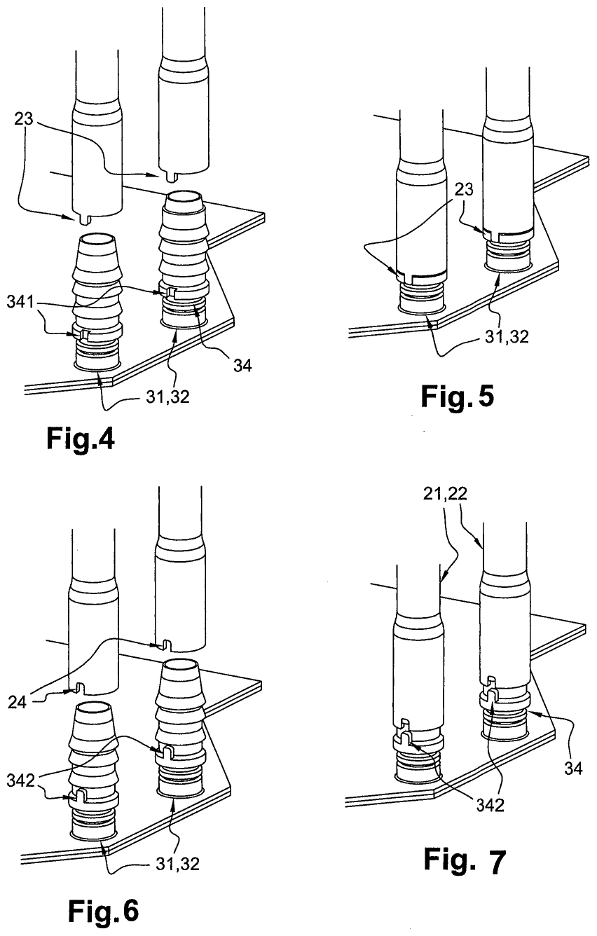

According to a first embodiment, illustrated in FIGS. 4 and 5, a notch 341 is formed in the collar 34 and extends over the total height of the collar 34.

The notch 341 could also extend over only a portion of the height of the collar 34, provided that the cavity formed is sufficient to receive an element of complementary shape.

This notch 341 is appropriate for cooperating with a lug 23, of complementary shape, that projects at the end of the pipe 21, 22.

FIG. 5 shows the pipes 21, 22 when they are positioned on the corresponding connection ducts 31, 32.

The peripheral edge of the free ends of the pipes 21, 22 is positioned against the upper peripheral surface of the corresponding collar 34, and each lug 23 nests in the corresponding notch 341 of the collar 34.

According to a second embodiment, illustrated in FIGS. 6 and 7, the notch 24 is formed on the peripheral edge of the free ends of the pipes 21, 22.

A lug 342, of profile complementary to the notch 24, is for its part formed on the collar 34 of the connection ducts 31, 32, and extends along the longitudinal axis of the corresponding connection duct.

More specifically, the lug 342 extends from the collar 342, along the main axis of the connection duct, toward the teeth 33.

In these two embodiments of the angular positioning means, the cooperation of the notch 341, 24 and the lug 23, 342 makes it possible, on the one hand, to secure the pipe 21, 22 and the connection duct 31, 32, and on the other hand to angularly position the end of the pipe 21, 22 relative to the connection duct 31, 32 in order to prevent any rotational movement.

The lug 23 and the notch 24 of the pipe 21, 22 are preferably produced by cutting the end of the pipe 21, 22.

The notch 341 and the lug 342 of the collar 34 are preferably produced by machining or by forming.

It should be noted that each pipe and each collar can bear several lugs or notches.

It should be noted, moreover, that the heat exchanger of the invention can be used as a radiator in a motor vehicle.

1. A heat exchanger comprising:
an inlet duct; and
an outlet duct for a heat transfer fluid, onto which ducts a supply pipe and a discharge pipe for the heat transfer fluid are respectively configured to be inserted,
wherein said inlet duct and said outlet duct each have, on an outer surface, means for sealing and retaining said corresponding pipe, and a collar forming a stop for limiting the insertion of the pipe onto said corresponding duct.

2. The heat exchanger as claimed in claim 1, wherein one end of said inlet duct and one end of said outlet duct are secured respectively to an inlet port and an outlet port for the heat transfer fluid that are borne by said heat exchanger.

3. The heat exchanger as claimed in claim 2, wherein said collar is situated in the vicinity of the end of said duct that is secured to said port.

4. The heat exchanger as claimed in claim 1, wherein said collar extends at least partially over the outer surface of said duct.

5. The heat exchanger as claimed in claim 1, wherein said sealing and retaining means comprise at least one circular tooth that is borne by the outer surface of said duct.

6. The heat exchanger as claimed in claim 5, wherein said at least one tooth has a cross section in the form of a truncated cone of which the base faces said collar.

7. The heat exchanger as claimed in claim 6, wherein said sealing and retaining means comprise three circular teeth that are spaced along the outer surface of the duct.

8. The heat exchanger as claimed in claim 1, wherein said inlet duct and said outlet duct each have means for the angular positioning of said corresponding pipe on said duct that are intended to cooperate with complementary angular positioning means formed in each of said pipes.

9. The heat exchanger as claimed in claim 8, wherein said angular positioning means comprise at least one notch formed in said collar, for cooperating with at least one lug borne by said pipe.

10. The heat exchanger as claimed in claim 8, wherein said angular positioning means comprise at least one lug borne by said collar, for cooperating with at least one notch formed in said pipe.

11. A heat exchanger comprising:
an inlet duct and an outlet duct for a heat transfer fluid, onto which ducts a supply pipe and a discharge pipe for the heat transfer fluid are respectively configured to be inserted,
wherein said inlet duct and said outlet duct each have, on an outer surface, means for sealing and retaining said corresponding pipe, and a collar forming an axial stop for limiting the insertion of the pipe onto said corresponding duct,
wherein said means for sealing and retaining establish a seal between the each duct and the corresponding pipe to prevent any leakage of the heat transfer liquid circulating in the inlet and outlet ducts,
and wherein the means for sealing and retaining lock the pipe in position on the corresponding duct, once the end of the corresponding duct has come into contact with the collar.
